(19) United States
(12) Patent Application Publication
(10) Pub. No.: US 2026/0168574 A1
(43) Pub. Date: Jun. 18, 2026

(54) BRAKE SYSTEM FOR A WORK VEHICLE

(71) Applicant: Deere & Company, Moline, IL (US)

(72) Inventors: Martin L. Meek, JR., Coffeyville, KS (US); Kevin M. Allen, Bartlesville, OK (US); Shantanu S. Joshi, Pune (IN); Galen R. Love, Independence, KS (US)

(21) Appl. No.: 18/980,452

(22) Filed: Dec. 13, 2024

(51) Int. Cl. F16H 63/34

(52) U.S. Cl. CPC F16H 63/345

(57) ABSTRACT

A brake system for a work vehicle having ground-engaging members supporting a chassis includes a service brake for stopping movement of the ground-engaging members when the service brake is engaged and a park brake for preventing further movement of the ground-engaging members after movement of the ground-engaging members has been stopped by the service brake. The park brake includes a friction pack and an actuator selectively engaging the friction pack to impede rotation of one or more of the ground-engaging members. A ground speed sensor generates ground speed signals indicative of a ground speed of the work vehicle and a brake activation sensor that generates a brake activation signal each time the actuator engages the friction pack. A controller having a processing and memory architecture is configured to execute logic instructions to accumulate the brake activation signals generated by the brake activation sensor, associate the brake activation signals with the ground speed signals received from the ground speed sensor, determine if the actuator engaged the friction pack while the ground-engaging members were in motion based the brake activation signals and the ground speed signals and in response estimate a holding capability of the park brake, and generate a service alert signal to an output device of the work vehicle when the estimated holding capability of the brake is less than a predetermined threshold holding capability.

### CROSS-REFERENCE TO RELATED APPLICATION(S)

Not applicable.

### STATEMENT OF FEDERALLY SPONSORED RESEARCH OR DEVELOPMENT

Not applicable.

### FIELD OF THE DISCLOSURE

This disclosure generally relates to braking systems for work vehicles and in particular a park brake system for work vehicles.

### BACKGROUND OF THE DISCLOSURE

Heavy-duty work vehicles, such as those used in the agricultural, construction, forestry, and mining industries, may utilize various propulsion systems and drive trains to provide tractive power to ground-engaging members such as wheels or tracks for travel and work operations of the work vehicle. Such work vehicles typically include a separate service brake and park brake. Typically, the service brake is actuated to reduce speed of and/or bring to a stop a moving work vehicle. The park brake is typically actuated to keep the work vehicle stationary after the vehicle is stopped and the engine thereof is idling or operation of such engine has been terminated. However, there may be situations in which the park brake maybe actuated while the vehicle is in motion such as, for example, if operation of the service brake alone is inadequate to bring the moving vehicle to a stop.

### SUMMARY OF THE DISCLOSURE

The present disclosure provides a brake system for a work vehicle having ground-engaging members supporting a chassis, the work vehicle. The brake system includes a service brake and a park brake. The service brake is configured to stop movement of the ground-engaging members when the service brake is engaged. The park brake is configured to prevent further movement of the ground-engaging members after movement of the ground-engaging members has been stopped by the service brake. The park brake includes a friction pack and an actuator selectively engaging the friction pack to impede rotation of one or more of the ground-engaging members. The brake system further includes a ground speed sensor that generates ground speed signals indicative of a ground speed of the work vehicle, a brake activation sensor that generates a brake activation signal each time the actuator engages the friction pack, and a controller having a processing and memory architecture. The controller is configured to execute logic instructions to accumulate the brake activation signals generated by the brake activation sensor, associate the brake activation signals with the ground speed signals received from the ground speed sensor, determine if the actuator engaged the friction pack while the ground-engaging members were in motion based on the brake activation signals and the ground speed signals and in response estimate a holding capability of the park brake. The controller is also configured to generate a service alert signal to an output device of the work vehicle when the estimated holding capability of the park brake is less than a predetermined threshold holding capability.

The present disclosure also provides a work vehicle that includes ground-engaging members supporting a chassis, a service brake for stopping movement of the ground-engaging members when the service brake is engaged, and a park brake for preventing further movement of the ground-engaging members after movement of the ground-engaging members has been stopped by the service brake. The park brake includes a friction pack and an actuator selectively engaging the friction pack to impede rotation of one or more of the ground-engaging members. The work vehicle also includes a ground speed sensor that generates ground speed signals indicative of a ground speed of the work vehicle, a brake activation sensor that generates a brake activation signal each time the actuator engages the friction pack, a controller having a processing and memory architecture. The controller is configured to execute logic instructions to accumulate the brake activation signals generated by the brake activation sensor, associate the brake activation signals with the ground speed signals received from the ground speed sensor, determine if the actuator engaged the friction pack while the ground-engaging members were in motion based the brake activation signals and the ground speed signals and in response estimate a holding capability of the park brake. In addition, the controller is configured to generate a service alert signal to an output device of the work vehicle when the estimated holding capability of the park brake is less than a predetermined threshold holding capability.

In some aspects or embodiments, the brake activation signals include a braking force amplitude and a braking duration. In some embodiments, the controller assesses the braking force amplitude and the braking duration of the brake activation signals to estimate the holding capability of the park brake. In other embodiments, the controller determines if an extreme brake event has occurred when the braking force amplitude is above a predetermined threshold braking force and the braking duration is below a predetermined threshold braking duration and in response the controller generates the service alert corresponding to the extreme brake event. In further embodiments, the controller applies a reduction factor to the estimated holding capability based on the extreme brake event. In still further embodiments, the reduction factor varies based on a magnitude of the sensed braking force amplitude over the predetermined braking force threshold. In some cases, the reduction factor varies based on a magnitude of the sensed braking duration under the predetermined braking duration threshold. In other cases, the controller generates the service alert based on the extreme brake event even if the estimated holding capability is greater than the predetermined threshold holding capability. In some embodiments, the extreme brake event corresponds to an emergency stop condition.

In some aspects and embodiments, the assessment of the holding capability of the brake is based on a plurality of ground speed signals received between receipt of the brake activation signal and when movement of the ground-engaging members has ceased.

### BRIEF DESCRIPTION OF THE DRAWINGS

FIG. 1 is an example work vehicle in the form of an agricultural tractor in which a brake system of the present disclosure may be incorporated;

FIG. 2 is a schematic diagram of a portion of an example driveline assembly including the brake system of the work vehicle of FIG. 1;

FIG. 3 is an isometric view of a park brake of the driveline assembly of FIG. 2;

FIG. 4 is a sectional view of the park brake of FIG. 3 taken along a line 4-4 of FIG. 3 with parts omitted for clarity;

FIG. 5 is a sectional view of the portion of the park brake shown in FIG. 4, with additional parts omitted for clarity; and

FIGS. 6 and 6A are flowcharts to illustrate steps undertaken by a control system of the work vehicle of FIG. 1.

Like reference symbols in the various drawings indicate like elements.

### DETAILED DESCRIPTION

The following describes one or more example embodiments of the disclosed brake system for a work vehicle as shown in the accompanying figures of the drawings described briefly above. Various modifications to the example embodiments may be contemplated by one of skill in the art. Discussion herein focuses on the brake system being for a work vehicle, such as an agricultural tractor, but the brake system disclosed herein may be utilized in other contexts, including other work vehicle platforms in the agriculture, construction, forestry, mining, and other industries.

### Overview

A work vehicle includes a chassis, a power generating engine, a transmission, a plurality of ground-engaging members (e.g., wheels, tracks, etc.), and a driveline. The driveline transfers power generated by the engine through the transmission and to the ground-engaging members to provide tractive power thereto. In particular, the driveline includes a driveshaft, one or more axles, and one or more differentials that couple the driveshaft to corresponding ones of the one or more axles. Power is generated by the engine and transmitted to the driveshaft by the transmission to cause rotation of the driveshaft and such rotation causes rotations of the one or more axles via the differential. The work vehicle also includes a service brake, a park brake separate from the service brake, and a park brake control. As would be understood by one who has ordinary skill in the art, the service brake may be disposed on the axle proximate to the one or more ground-engaging members to cause the work vehicle to slow down and/or to stop.

The park brake in accordance with the present disclosure is disposed along the driveshaft between the transmission and the differential and is typically engaged after the work vehicle is stopped to inhibit rotation of the driveshaft and thereby prevent unintended rolling or other motion of the work vehicle. However, the park brake may be engaged in an emergency situation to assist the service brake in slowing down or stopping the work vehicle. Further, an operator may accidentally engage the park brake while the work vehicle is in motion but such engagement is atypical. The park brake includes a casing secured to the chassis or other fixed component of the work vehicle and the casing defines an internal cavity. A portion of the driveshaft is disposed in the cavity and a friction pack is circumferentially disposed between the portion of the driveshaft and the casing. The friction pack includes a plurality of friction discs and a plurality of separator plates interleaved with one another. In some embodiments, the friction discs are secured to the casing and remain stationary while the drive shaft rotates because the casing is secured to the chassis of the work vehicle. The separator plates are secured to the portion of the driveshaft in the casing so that the separator plates corotate with the driveshaft. The friction discs and separator plates are separated from one another when the park brake is not set so corotation of the separator plates with the drive shaft is not impeded by the friction discs. However, as described in detail below, setting the park brake causes the plurality of friction discs and the plurality of separator plates to move relative to one another until a face of each friction disc engages and interacts with a face of an adjacent separator plate to create friction therebetween. Such friction between the faces impedes the rotation of the driveshaft to which the separator plates are secured and thereby prevents inadvertent motion of the ground-engaging members of the work vehicle. The faces of the plurality of friction discs and the plurality of separator plates remain in contact in this manner until the park brake is released.

In some embodiments, the separator plates and the friction discs include protrusions or keys that are mated with splines formed along the portion of the driveshaft in the casing and the casing, respectively. Setting the park brake while the driveshaft is rotating (i.e., when the one or more ground-engaging members are in motion) may cause unwanted wear on the faces of the friction discs and/or separator plates that reduces the friction therebetween when such faces are brought into contact and interact. Further, setting the park brake in this manner may also cause wear of the keys and/or splines used to secure the separator plates to the driveshaft and the friction discs to the casing that compromises how securely the separator plates and the friction discs are held relative to the casing and the driveshaft, respectively. Such wear on the faces, keys, and/or splines may reduce the holding capability (i.e., effectiveness) of the park brake when set. Further, setting the park brake when the vehicle is in motion may generate heat within the park brake that may reduce the useful life of the components of the park brake such as seals, bearings, friction discs, separator plates, and the like.

Although the brake system described herein includes embodiments of the park brake in which the separator plates are secured to the driveshaft and the friction discs are secured to the casing, the brake system may be readily adapted to include other embodiments of the park brake in which the friction plates are secured to and corotate with the driveshaft and the separator plates are secured to the casing.

The brake system includes a controller that monitors brake activation signals generated by a brake activation sensor each time the park brake is activated and one or more ground speed signals indicative of the ground speed of the work vehicle to determine if the park brake was engaged while one or more ground-engaging members of the work vehicle was in motion. If so, the controller estimates a reduction in the holding capability of the park brake in accordance with such signals and generates a service alert to an output device of the work vehicle when such holding capability is less than a predetermined holding capability. In some cases, the brake activation signal may include a braking force amplitude and a braking duration. The braking force amplitude may be indicative of a force applied by the operator to set (or engage) the park brake. Such force may be that applied to operate a park brake control (e.g., a park brake pedal, a park brake lever, etc.) from a disengaged to an engaged position to set the park brake. The duration may indicate the amount of elapsed time while the park brake control is moved from the disengaged position to the engaged position.

In some cases, the brake system controller assesses the braking force amplitude and braking duration each time the park brake is set to estimate the holding capability of the park brake. Further, the brake system controller may determine an extreme braking situation has occurred if the braking force amplitude is above a predetermined threshold and the braking duration is below a predetermined threshold. That is, the park brake control was forcefully and rapidly moved from the disengaged to the engaged position as may occur in an emergency situation.

The brake system controller may adjust a predetermined holding capability or a previously calculated holding capability by a reduction factor each time the park brake is set while at least one of the ground-engaging members of the work vehicle is in motion and/or each time an extreme braking situation is determined. Further, such reduction factor may be determined in accordance with one or more of the braking force amplitude, the braking force duration, the ground speed of the one or more ground-engaging members, a plurality of ground speeds of the one or more ground-engaging members between receipt of the brake activation signal and movement of the one or more ground-engaging members ceases, and/or an estimate of an increase in a temperature of components of the park brake as a result of setting the partk brake, an estimated amount of braking energy absorbed by the park brake when set, or a combination thereof.

### Example Brake System

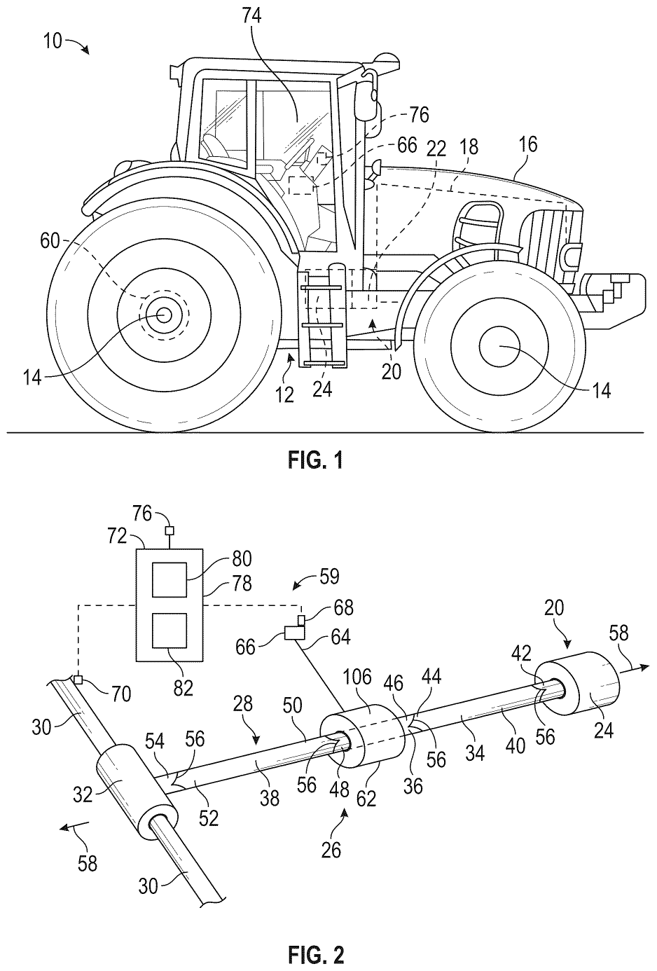

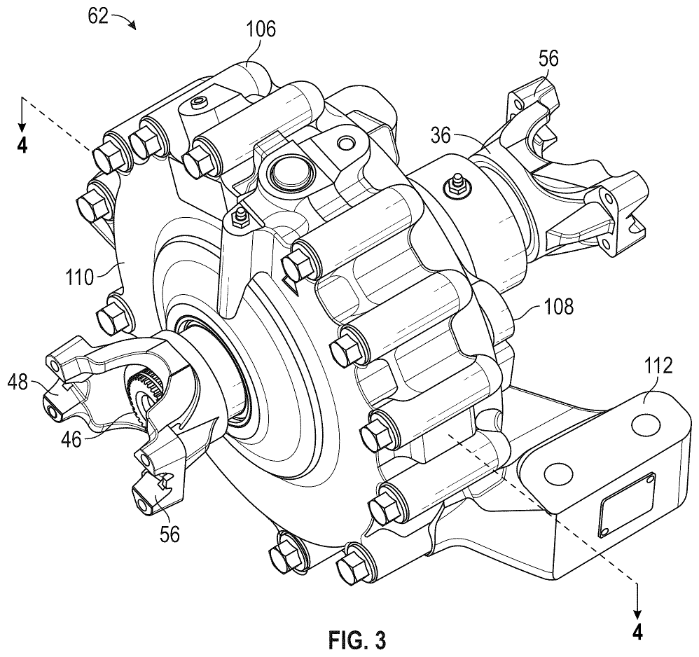

Referring to FIGS. 1 and 2, a work vehicle 10 is shown that can implement embodiments of the present disclosure. In the illustrated example, the work vehicle 10 is depicted as an agricultural tractor. It will be understood, however, that other configurations may be possible, including configurations with the work vehicle 10 as a different kind of tractor, a harvester, a log skidder, a grader, or one of various other work vehicle platforms. The work vehicle 10 includes a chassis or frame 12 carried on front and rear ground-engaging members 14 such as wheels, tracks and the like. Positioned on a forward end region of the chassis 12 is an engine housing 16 within which is located an engine system 18. The engine system 18 provides power via an associated powertrain 20 comprising for example, an engine 22 and a transmission 24, to a driveline assembly 26. The driveline assembly 26 includes a driveshaft 28 that, in turn, transmits power to one or more axles 30 via a differential 32. The powertrain 20 may also provide power to a power take-off shaft for powering an implement on or associated with the work vehicle 10, for example.

The driveshaft 28 includes a transmission-side portion 34, a central portion 36, and an axle-side portion 38. A first end 40 of the transmission-side portion 34 of the driveshaft 28 is secured to an output shaft 42 of the transmission 24 and a second end 44 of the transmission-side portion 34 is secured to a first end 46 of the central portion 36. A second end 48 of the central portion 36 of the driveshaft 28 is secured to a first end 50 of the axle-side portion 38 of the driveshaft 28. A second end 52 of the axle-side portion 38 is secured to an input shaft 54 of a differential 32. In one embodiment, clevises or other attachment assemblies 56 and associated components may be used to secure the transmission-side portion 34 of the driveshaft 28 to the output shaft 42 of the transmission 24, the central portion 36 of the driveshaft 28 to the transmission-side portion 34 and the axle-side portion 38 of the driveshaft 28, and the axle-side portion 38 to the input shaft 54 of the differential 32. Other ways of attaching the portions 34,36, 38 of the driveshaft 28 to one another and to secure the driveshaft 28 to the output shaft 42 of the transmission 24 and the input shaft 54 of the differential 32 apparent to one who has ordinary skill in the art may be used in other embodiments.

During operation, the transmission 24 uses power generated by the engine 22 to rotate the output shaft 42 thereof. Rotation of the output shaft 42 causes simultaneous rotation of the driveshaft 28 (i.e., the transmission-side portion 34, the central portion 36, and the axle-side portion 38 thereof) about a drive axis 58 (i.e., axis of rotation) thereof, and rotation of driveshaft 28 is transmitted by the differential 32 to the axles 30 to cause rotation thereof.

As described in greater detail below, the work vehicle 10 includes a brake system 59 comprising a service brake 60 (FIG. 1), a park brake 62, a park brake actuator 64, a park brake control 66, a brake activation sensor 68, a ground speed sensor 70, and a controller 72.

The service brake 60 is disposed on the axle 30 proximate the one or more the ground-engaging members 14. The service brake 60 may be a disk brake, a drum brake, or another type of brake that is configured to reduce the velocity of or cease movement of the ground-engaging members 14 and thus the work vehicle 10.

The park brake 62 of the work vehicle 10 is configured to prevent further movement of the ground-engaging members 14 after movement thereof has been stopped by the service brake 60. In some embodiments, the park brake 62 is a spring applied hydraulic release (SAHR) brake. Although, the park brake 62 may be another type of suitable brake apparent to one who has ordinary skill in the art. The park brake 62 is disposed on and surrounds the central portion 36 of the driveshaft 28. The park brake 62 is coupled, for example, by the park brake actuator 64 such as a rod, a cable, a hydraulic assembly, and the like to a park brake control 66 disposed in an operator cabin 74 of the work vehicle 10. The park brake control 66 may be a lever, a button, an electronic pushbutton, or other mechanical or electronic/digital control mechanism that is operable by an operator to set and release the park brake 62. The brake activation sensor 68 generates a signal and/or data when the park brake control 66 is operated to set or release the park brake 62. The signal and/or data generated by the brake activation sensor 68 indicates when the operator uses the park brake control 66 to set the park brake 62, an amplitude and duration of the force applied to the park brake control 66 to set the park brake 62. The brake activation sensor 68 also generates a signal and/or data when the operator uses the park brake control 66 to release the park brake 62.

The ground speed sensor 70 generates a signal and/or data that is indicative of the ground speed of the work vehicle 10 by, for example, measuring a speed of the ground-engaging members 14, a rotational speed of the drive shaft 28, a rotational speed of the axle 30, and the like.

As described in greater detail below, the controller 72 of the work vehicle 10 monitors and accumulates the signals and/or data generated by the brake activation sensor 68 and the ground speed sensor 70 and estimates a holding capability of the park brake 62. If the holding capability of the park brake 62 is less than a predetermined holding capability, the controller 72 causes an output device 76 disposed in the operator cabin 74 of the work vehicle 10 to alert the operator that the holding capability of the park brake 62 may be compromised. Generally, the controller 72 may implement any of the functions described herein. The output device 76 may be a light emitting device, a sound emitting device, a haptic device, or a combination thereof that provides the alert to the operator.

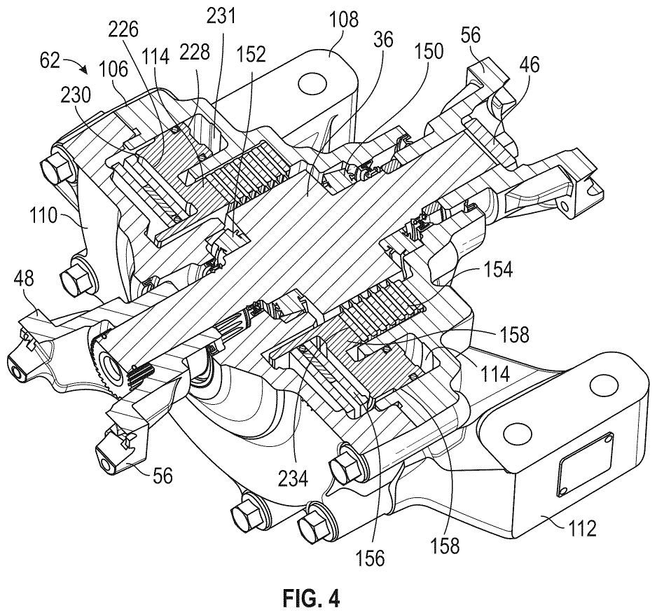

Referring also to FIG. 3, the controller 72 may be implemented using hardware, software, firmware, or combinations thereof. In the illustrated embodiment, the controller 72 may be implemented by one or more suitably programmed computer-based device(s) 78, some or each having a processing device 80 and a memory device 82. The memory device 82 has stored therein, among other things, programming instructions executed by one or more processing devices 80 to cause the controller 72 to undertake functions of the brake system 59 as described herein.

Each computer-based device 78 may comprise, e.g., a computer, a device using one or more application specific integrated circuits (ASIC's) and/or field-programmable gate arrays (FPGA's), and/or combinations thereof. Such device 78 may be unitary or may be distributed multiple computing devices, and one or more such computing devices may be installed locally on or remote from the work vehicle 10. Each computer-based device 78 may communicate with another computing device over one or more network(s) such as a local area network (LAN), a control area network (CAN), a cellular network, a wide area network (WAN) such as the Internet, and the like. The controller 72 also may be coupled to and responsive to one or more user device(s) (not shown) such as a keyboard, a mouse, a display, a touchscreen, a joystick, etc. (not shown) via which an operator may monitor and direct operation of the work vehicle 10.

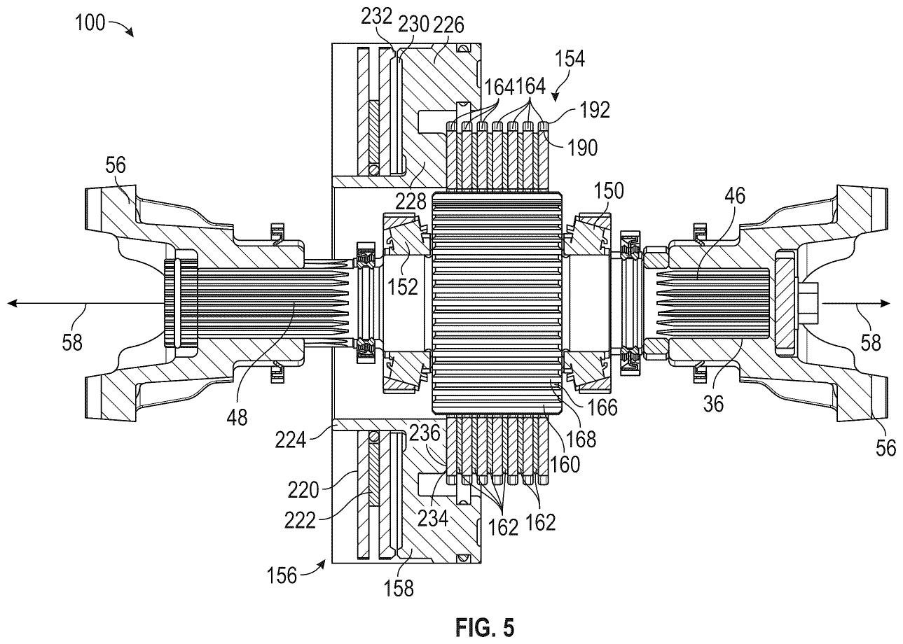

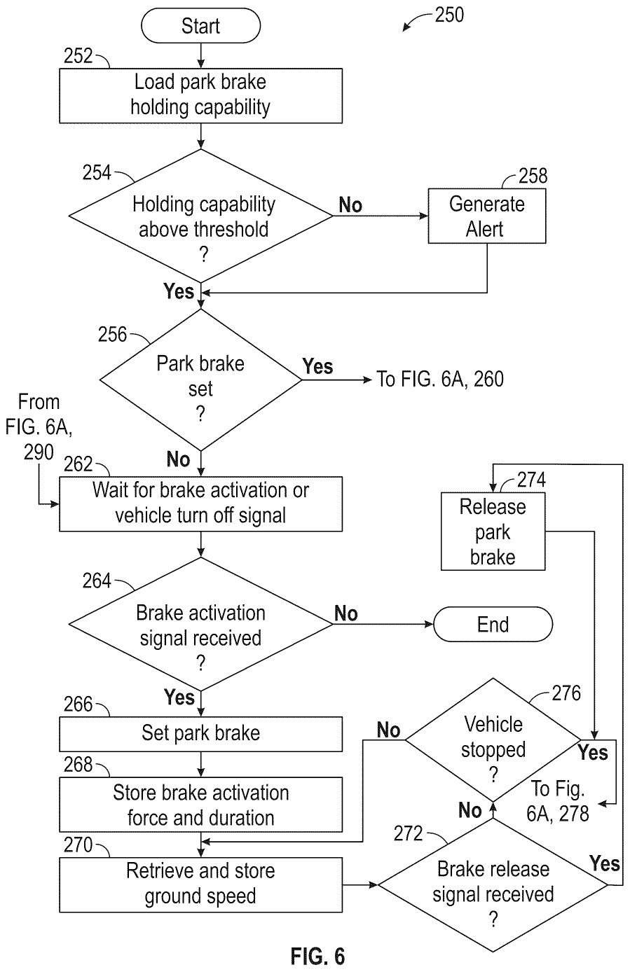

The park brake 62 includes a casing 106 and the central portion 36 of the drive shaft 28 passes through the casing 106. Referring also to FIGS. 3-5, the casing 106 comprises a transmission-side sub-casing 108 and an axle-side sub-casing 110. In some embodiments, the transmission-side sub-casing 108 includes a park brake mount 112 that may be fixedly secured to the chassis 12 or another fixed element of the work vehicle 10 so that the casing 106 remains stationary while the central portion 36 rotates in response to power generated by the engine 22. In other embodiments. the park brake mount 112 may be disposed on the axle-side sub-casing 110.

The transmission-side sub-casing 108 and the axle-side sub-casing 110 are joined together to form the casing 106 that defines a cavity 114 in which the components of the park brake 62 are disposed. Such components include a transmission-side bearing 150, an axle-side bearing 152, a friction pack 154, a piston spring assembly 156, and a piston casing 158. The friction pack 154, the piston spring assembly 156, and the piston casing 158 are disposed circumferentially about and surround the central portion 36 (and thus the drive axis 58).

The central portion 36 includes a splined hub 160. The transmission-side bearing 150 and the axle-side bearing 150 are disposed on opposite sides of the splined hub 160 along the drive axis 58. The first end 46 of the central portion 36 of the driveshaft 28 is passed through and supported by the transmission-side bearing 150 and the second end 48 of the central portion 36 is passed through and supported by the axle-side bearing 152. In some embodiments, one or both of the transmission-side bearing 150 and the axle-side bearing 152 are journaled bearings that allow rotation of the central portion 36 of the driveshaft 28 relative to the casing 106. Other types of bearings and support members instead of or in addition to the bearings 150, 152 that can support and facilitate such rotation of the central portion 36 apparent to one who has ordinary skill in the art may be used in other embodiments.

The splined hub 160 is configured to corotate with the central portion 36. In some embodiments, the splined hub 160 is a component separate from the central portion 36 that is secured thereto and in other embodiments the splined hub 160 is integrally formed with the central portion 36. The friction pack 154 surrounds the splined hub 160 and includes a plurality of separator plates 162 and a plurality of friction discs 164 interleaved with one another. The splined hub 160 includes a plurality of keys or splines 166 separated by a plurality of grooves 168. The plurality of keys 166 and the plurality of grooves 168 of the splined hub 160 extend along a direction parallel to the drive axis 58 and are distributed circumferentially about the splined hub 160. Each separator plate 162 is an annular disc having protrusions (not shown) extending inwardly from the inner periphery and notches between adjacent protrusions that are sized and formed to mate with corresponding keys 166 and grooves 168 of the splined hub 160 as each separator plate 162 is slid on to the splined hub 160 in a direction parallel to the drive axis 58. Thus, each separator plate 162 is supported by the splined hub 160 so that the separator plate 162 corotates with the splined hub 160 yet is able to move along the splined hub 160 in a direction parallel to the drive axis 58. Other ways apparent to one who has ordinary skill in the art to dispose the plurality of separator plates 162 on the central portion 36 so that the plurality of separator plates 162 are movable in a direction parallel to the drive axis 58 and corotate with the central portion 36 may be used in other embodiments.

A portion of an inner wall (not shown) of the transmission-side sub-casing 108 is splined and includes a plurality of grooves and a plurality of keys defined by adjacent grooves. Each of the plurality of friction discs 164 is an annular disc having an outer periphery in which a plurality of keys and a plurality of grooves are formed. The pluralities of keys and grooves of the friction disc 164 are sized and formed to mate with the grooves and keys, respectively, as the friction disc is slid into in the inner wall of the transmission-side sub-casing 108. As noted above, the transmission-side sub-casing 108 is immovably secured to the chassis 12 or another fixed component of the work vehicle 10 so that such sub-casing 108 does not corotate with the driveshaft 28. Thus, disposing each friction disc 164 in the transmission-side sub-casing 108 in this manner prevents corotation of the friction disc 164 with the driveshaft 28 and allows the friction disc 164 to move relative to the transmission-side sub-casing 108 in a direction parallel to the drive axis 58.

In one embodiment, the piston spring assembly 156 includes one or more Belleville spring(s) 220 separated by one or more spacer(s) 222. Each Belleville spring 220 and spacer 222 is an annular disc that surrounds the central portion 36 of the drive shaft 28. The piston casing 158 is configured to be movable parallel to the drive axis 58 and includes an annular flange 224 that passes through central openings of the one or more Bellville spring(s) 220 and the one or more spacer(s) 222. A piston 228 is disposed in the piston casing 158 between the spring assembly 156 and the friction pack 154 and is configured to be movable in a direction parallel to the drive axis 58 of the driveshaft 28. The piston 228 includes a spring side portion 226 having at least one protrusion 230 extending therefrom toward the piston spring assembly 156. Each protrusion 230 is in contact with a corresponding protrusion 232 on the Belleville spring 220 proximate the spring side portion 226. Further, the piston 228 is disposed in the piston casing 158 such that a hydraulic fluid chamber 231 is formed therebetween.

In some embodiments, when the park brake 62 is released or disengaged, hydraulic fluid is pumped or otherwise supplied into the hydraulic fluid chamber 231 to apply pressure to and drive the piston 228 toward the one or more Belleville spring(s) 220 to hold such spring(s) 220 in a loaded state. Further, driving the piston 228 in this manner separates a wall 234 of the piston 228 from a face 236 (i.e., one of the opposite faces 198, 200) of the friction disc 164 nearest the piston 228. In addition, the face 198 or 200 of each friction disc 164 is separated from the face 194 or 196 of the separator plate 162 adjacent to such friction disc 164. Thus, the plurality of separator plates 162 are free to corotate with the central portion 36 without being impeded by the plurality of friction discs 164. In such embodiments, the park brake control 66 may be operated to set or engage the park brake 62 by pumping or evacuating the hydraulic fluid from the hydraulic fluid chamber 231, thereby releasing the pressure applied to the piston 228 and allowing the one or more Belleville spring(s) 220 to release (i.e., de-load). In particular, releasing the one or more Belleville spring(s) 220 causes the protrusion 232 on the Bellville spring 220 to move toward and push against the protrusion 230 on the spring side portion 226 of the piston 228 and thereby drive the piston 228 toward the friction pack 154. The piston 228 moves toward the friction pack 154 until the wall 234 of the piston 228 contacts the face 236 of the friction disc 164 nearest the piston 228 and continues to drive the faces of the plurality of friction discs into contact with adjacent faces of the plurality of separator plates 162. The one or more Belleville spring(s) 220 and the piston 228 are configured to force the plurality of friction discs 164 toward the plurality of separator plates 162 in this manner to cause friction between the friction discs 164 and separator plates 162 that impedes corotation of the plurality of separator plates 162 with the central portion 36 of the drive shaft 28.

In some embodiments, the brake activation sensor 68 is external to the park brake 62 and monitors operation of the park brake actuator 64 to sense when, with how much force, and for how long the operator has operated the park brake control 66 to set the park brake 62 and thereby cause the plurality of separator plates 162 and the plurality of friction discs 164 to be driven toward another and thereby impede rotation of the driveshaft 28. In other embodiments, the brake activation sensor 68 may be integrated into the park brake 62 and may directly sense movement of the piston portion 228 (or another component of the park brake 62) to drive the plurality of separator plates 162 and the plurality of friction discs 164 toward another. For example, the brake activation sensor 68 may be disposed in the park brake 62 such that the brake activation sensor 68 may monitor movement (e.g., velocity) of the piston portion 228. The controller may 72 may use the signals/data from such brake activation sensor 68 and a spring curve associated with the particular Belleville springs 220 used in the park brake to determine an amount of force applied to move the piston portion 228. In other embodiments, the brake activation sensor 68 may be a pressure sensor disposed in the park brake 62 to measure the pressure with which hydraulic fluid in the hydraulic fluid chamber 231 is released when the park brake 62 is engaged and the controller uses the signals/data supplied by such brake activation sensor 68 and the spring curve associated with the particular Belleville springs 220 to estimate movement of the piston portion 228, and thereby estimate the amount of force applied to move the pistorn portion 228.

The controller 72 uses signals/data developed by the brake activation sensor 68 (either internal or external to the park brake 62) regarding force applied engage the park brake to move the piston portion 228 to estimate, for example, braking energy absorbed by the park brake 62 when the park brake is engaged and/or an amount of heat to which the separator plates 162 and friction discs 164 are exposed because of such engagement.

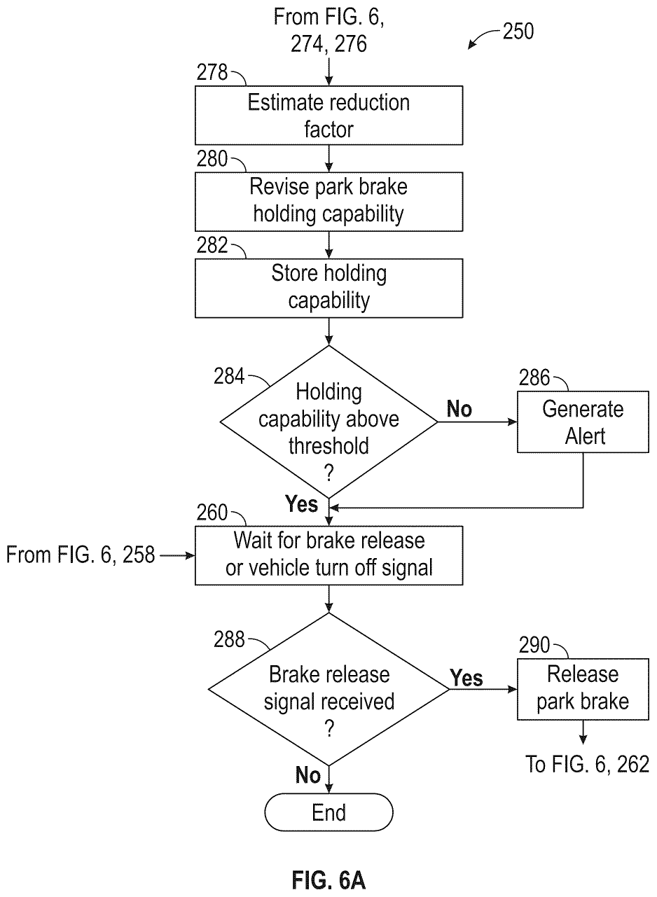

FIGS. 6 and 6A show a flowchart 250 of processing undertaken by the controller 72 to monitor holding capability of the park brake 62 of the work vehicle 10. Referring to FIGS. 1-6A, at step 252 the controller 72 loads from the memory device 82 a value of a previously stored park brake holding capability estimate, if any. If no park brake holding capability estimate has been stored in the memory device 82, the controller 72 sets the value of the park brake holding capability estimate to a value that represents a maximum park brake holding capability, also at step 252. In some embodiments, the value of the park brake holding capability estimate is a numeric value between a minimum park brake holding capability and the maximum park brake holding capability, for example, 0 and 100, respectively. Other ways of representing the park brake holding capability apparent to one who has ordinary skill in the art may be used in other embodiments.

At step 254, the controller 72 checks if the park brake holding capability estimate is greater than a predetermined threshold holding capability. In some embodiments, such predetermined threshold may be a predetermined percentage of the maximum park brake holding capability, for example, 10 percent or 20 percent. If the park brake holding capability is greater than the predetermined threshold holding capability, the controller 72 proceeds to step 256. Otherwise, the controller 72 transmits a service alert signal to the output device 76 that causes the output device 76 to generate an alert that may be one or more of an alphanumeric code, a lighted icon, a sound, text such as “Immediate Park Brake Service Required,” a vibration or other haptic output, and the like, at step 258 and then proceeds to step 256.

At step 256, the controller 72 determines if the park brake 62 is set and, if so, proceeds to step 260 (FIG. 6A) described in greater detail below. Otherwise, the controller 72, at step 262, waits for a brake activation signal generated by the brake activation sensor 68 or a signal generated by a supervisory or other controller (not shown) that indicates the operator has turned off the work vehicle 10. Upon receiving one of these signals, the controller 72 at step 264 determines if the brake activation signal was received. If the brake activation signal was not received (i.e., the operator turned off the work vehicle 10), the controller 72 exits. Otherwise, at step 266, the controller 72 sets the park brake 62 by causing the piston 228 to drive toward the friction pack 154 so that the plurality of separator plates 162 and the plurality of friction discs 164 are forced against one another to generate friction therebetween that impedes rotation of the drive shaft 28 as described above. In some embodiments, the controller 72 does not cause the park brake 62 to be set. Instead, operation of the park brake actuator 64 by the operator causes the park brake control 66 to set the park brake 62 mechanically or otherwise by, for example, opening a valve or starting a pump that causes evacuation of the hydraulic fluid from the hydraulic chamber 231 as described above. In these embodiments, the controller 72 simply monitors when the park brake actuator 64 is operated and the force and duration of such operation. In such embodiments, the controller 72 proceeds from step 264 to step 268 when the controller 72 determines the brake activation signal has been received at step 264.

At step 268, the controller 72 stores in the memory device 82 a timestamp of when the brake activation signal was received, a value that represents an amount of braking force applied to the park brake control 66, and a value that represents a duration of how long the braking force was applied. At step 270, the controller obtains a ground speed value from the ground speed sensor 70 that indicates a speed of the ground-engaging members 14 of the work vehicle 10. The controller 72 stores a timestamp of when the ground speed value was obtained and the ground speed value in the memory device 82.

At step 272, the controller 72 determines if a brake release signal has been received from the brake activation sensor 68 that indicates the operator wishes to release the park brake 62. If such signal has been received, the controller 72 causes the piston 228 to move away from the friction pack 154, e.g., by, for example, operating a pump to supply hydraulic fluid into the hydraulic fluid chamber 231 of the park brake 62. As described above, moving the piston 228 in this manner allows the plurality of separator plates 162 to and the plurality of friction discs 164 to separate from one another, which allows the driveshaft 28 to rotate. Thereafter, the controller 72 proceeds to step 278 (FIG. 6A). In some embodiments, the controller 72 does not cause the brake 106 to release. Instead, operation of the park brake actuator 64 by the operator causes the park brake control 66 to release the park brake 62 by, for example, enabling hydraulic fluid to flow into hydraulic chamber 231 as described above. In such embodiments, the controller 72 proceeds from step 272 to step 278 in response to receipt of the brake release signal.

If at step 272, the controller 72 determines that no brake release signal has been received, the controller 72 determines if the work vehicle 10 has stopped moving at step 276. If the work vehicle 10 is still moving, the controller 72 proceeds to step 270 to obtain and store another ground speed value. In some embodiments, the controller 72 may wait a predetermined amount of time between step 276 and step 270. The controller undertakes steps 270 through 276 in this manner and obtains and stores one or more ground speed values in the memory device 82 until movement of the work vehicle 10 ceases. The controller 72 proceeds to step 278 (FIG. 6A) if the controller 72 determines at step 276 that the work vehicle 10 has ceased moving.

At step 278, the controller 72 develops a reduction factor (as described below) that is an estimate of an amount the brake holding capability of the park brake 62 was reduced due to setting the park brake 62 at step 266 and any movement of the work vehicle 10 that occurred thereafter. At step 280, the controller 72 adjusts the estimate of the holding capability of the park brake 62 in accordance with the reduction factor and at step 282 the controller 72 stores the adjusted estimate of the holding capability in the memory device 82.

At step 284, the controller 72 checks if the adjusted holding capability is greater than the threshold holding capability and, if so, the controller 72 proceeds to step 260. Otherwise, the controller 72 signals the output device 76 to generate an alert message at step 286 and then proceeds to step 260. In some embodiments, the controller 72 determines, also at step, 284, if an extreme brake event (described below) has occurred and proceeds to step 286 even if the holding capability is above the threshold holding capability.

At step 260, the controller 72 waits to receive a signal that the operator wishes to release the park brake 62 or has turned off the work vehicle 10. At step 288, the controller 72 determines if the signal received at step 260 indicates the operator wishes to release the park brake 62 and if so, proceeds to step 290 and causes the park brake 62 to be released as described above in connection with step 284 and returns to step 262 (FIG. 6). Further, as described above, in some embodiments the controller 72 does not release the park brake 62 but only monitors when the brake release signal is received and, in such embodiments, the controller 72 proceeds from step 288 to step 262 (FIG. 6) upon receipt of such signal.

If at step 288, the controller 72 determines that the signal received at 210 does not indicate that the operator wishes to release the park brake 62 and instead such signal indicates the operator wishes to turn of the work vehicle 10, the controller 72 exits.

The controller 72 may use various methods to estimate the reduction factor in step 278. In some embodiments, the controller 72 may determine if an extreme brake event has occurred that could cause substantial wear on components of the park brake 62. Such extreme brake events may include situations such as, for example, if actuation force greater than a threshold force was applied over a duration less than a threshold duration to set the park brake 62, the work vehicle 10 was moving at a velocity greater than a threshold velocity when the park brake 62 was set, and the like. Such extreme brake events may occur, for example, in response to an emergency situation perceived by the operator. Further, such extreme brake events may cause substantial wear on components of the park brake 62 such as, for example, wearing of the frictional material on faces of the plurality of frictional discs 164 of the park brake 62, deformation of keys and splines used to secure the separator plates 162 and friction discs 164 to the splined hub 160 and the casing 106, respectively, generation of excess heat that may damage and reduce the effectiveness of the components of the park brake 62, and the like. In some cases, even a single extreme brake event may be sufficient to substantially reduce the holding capability of the park brake 62. The controller 72, at step 278, evaluates the brake activation force and duration recorded at step 268 and the ground speed(s) recorded at steps 280 to determine if such an extreme brake event has occurred and if so, sets the reduction factor to a large value (e.g., 50, 60, or even more if the range of the value of holding capability is from 0 to 100). In some embodiments, the controller 72 signals the output device 76 to generate an alert message when an extreme brake event of sufficient magnitude has occurred even if the calculated reduction factor does not reduce the estimated holding capability below the threshold holding capability.

Even if a single extreme brake event is not sufficient to substantially reduce the holding capability of the park brake 62, the controller 72 develops the reduction factor at step 278 and reduces the value of the brake holding capability by such reduction factor at step 280 each time the brake actuation signal is received while the work vehicle 10 is not stopped. Thus, the value of brake holding capability stored by the controller 72 at step 282 reflects wear that may have accumulated over time as a result of multiple brake events. In particular, each time the brake activation signal is received, the controller 72 at step 278 evaluates one or more of the brake actuation force, the duration of the brake actuation, one or more ground speeds stored at step 270 until movement of the work vehicle 10 is ceased, the elapsed time between receiving the brake activation signal and ceasing of the movement of the work vehicle 10, an estimated amount of heat (i.e., rise in temperature) to which to the separator plates 160 and friction discs 162 are exposed, an estimated braking energy absorbed by the park brake 62 when set, and the like to determine the reduction factor. For example, in some embodiments, the controller 72 may sum the plurality of ground speeds stored over such elapsed time and use the value of such sum to determine the reduction factor, wherein a higher sum results in a higher reduction factor. In some cases, the relationship of the sum of the plurality of ground speeds may be linearly related to the reduction factor. In other cases, the sum of the plurality of ground speeds and the reduction factor may have an exponential or polynomial relationship with one another so that the reduction factor increases rapidly and non-linearly as the sum of the plurality of ground speeds increases. Further, controller 72 may adjust the reduction factor in accordance with the elapsed time necessary for the work vehicle 10 to come to a stop. Similarly, the controller 72 may sum over one or more application of the park brake the estimated heat which the separator plates 160 and friction discs 162 (and other components) are exposed and/or the estimated braking energy absorbed by the park brake each time the park brake is set and adjust the reduction factor accordingly. Such sum may be linearly related to the reduction factor or may have exponential or polynomial relationship with the reduction factor. Further, the reduction factor may be developed in accordance with a combination of the effects of movement of the vehicle 10 while the park brake 62 is set, estimated heat to which components of the park brake 62 are exposed, and estimated braking energy absorbed by the park brake 62.

Other ways to determine the reduction factor in accordance with the brake activation force, brake activation duration, the plurality of ground speeds, and the elapsed time to bring the work vehicle 10 to a stop apparent to one who has ordinary skill in the art may be used in other embodiments.

The embodiments disclosed herein may be used to retrofit an existing work vehicle 10 having a park brake 62 to estimate the holding capability thereof and provide an alert to the operator when the holding capability is below a predetermined threshold. The controller 72 may be readily added to or integrated into the control system of a work vehicle 10 that already has a brake activation sensor 68 and a ground speed sensor 70. Further, because such sensors 68, 70 may be external to the park brake 62, one or both of these sensors may be added if necessary to an existing work vehicle 10 without requiring a replacement of the park brake 62.

In addition, it should be apparent that the embodiments disclosed herein are not limited for use with the park brake 62 diposed in the driveline assembly 26 of the work vehicle 10 but may be adapted for use with a park brake that is disposed or integrated in other parts of the work vehicle 10 such as a housing, an axle, a differential, and the like.

Although the embodiments disclosed herein are described in connection with a controller for a park brake for a work vehicle, it should be apparent to one who has ordinary skill in the art that aspects of these embodiments may be adapted to other types of braking systems and/or other types of vehicles to prevent inadvertent movement of the vehicles after being stopped. Further, aspects of such embodiments may even be used in other types of brake systems not associated with vehicles as appropriate.

The terminology used herein is for the purpose of describing particular embodiments only and is not intended to be limiting of the disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

As used herein, unless otherwise limited or modified, lists with elements that are separated by conjunctive terms (e.g., “and”) and that are also preceded by the phrase “one or more of” or “at least one of” indicate configurations or arrangements that potentially include individual elements of the list, or any combination thereof. For example, “at least one of A, B, and C” or “one or more of A, B, and C” indicates the possibilities of only A, only B, only C, or any combination of two or more of A, B, and C (e.g., A and B; B and C; A and C; or A, B, and C).

The description of the present disclosure has been presented for purposes of illustration and description, but it is not intended to be exhaustive or limited to the disclosure in the form disclosed. Many modifications and variations will be apparent to those of ordinary skill in the art without departing from the scope and spirit of the disclosure. Explicitly referenced embodiments herein were chosen and described in order to best explain the principles of the disclosure and their practical application, and to enable others of ordinary skill in the art to understand the disclosure and recognize many alternatives, modifications, and variations on the described example(s). Accordingly, various embodiments and implementations other than those explicitly described are within the scope of the following claims.

What is claimed is:

1. A brake system for a work vehicle having ground-engaging members supporting a chassis, the work vehicle comprising:
a service brake for stopping movement of the ground-engaging members when the service brake is engaged;
a park brake for preventing further movement of the ground-engaging members after movement of the ground-engaging members has been stopped by the service brake, wherein the park brake includes a friction pack and an actuator selectively engaging the friction pack to impede rotation of one or more of the ground-engaging members;
a ground speed sensor that generates ground speed signals indicative of a ground speed of the work vehicle;
a brake activation sensor that generates a brake activation signal each time the actuator engages the friction pack; and
a controller having a processing and memory architecture and configured to execute logic instructions to:
accumulate the brake activation signals generated by the brake activation sensor;
associate the brake activation signals with the ground speed signals received from the ground speed sensor;
determine if the actuator engaged the friction pack while the ground-engaging members were in motion based the brake activation signals and the ground speed signals and in response estimate a holding capability of the park brake; and
generate a service alert signal to an output device of the work vehicle when the estimated holding capability of the park brake is less than a predetermined threshold holding capability.

2. The brake system of claim 1, wherein the brake activation signals include a braking force amplitude and a braking duration.

3. The brake system of claim 2, wherein the controller assesses the braking force amplitude and the braking duration of the brake activation signals to estimate the holding capability of the park brake.

4. The brake system of claim 2, wherein the controller determines if an extreme brake event has occurred when the braking force amplitude is above a predetermined threshold braking force and the braking duration is below a predetermined threshold braking duration and in response the controller generates the service alert corresponding to the extreme brake event.

5. The brake system of claim 4, wherein the controller applies a reduction factor to the estimated holding capability based on the extreme brake event.

6. The brake system of claim 5, wherein the reduction factor varies based on a magnitude of the sensed braking force amplitude over the predetermined braking force threshold.

7. The brake system of claim 5, wherein the reduction factor varies based on a magnitude of the sensed braking duration under the predetermined braking duration threshold.

8. The brake system of claim 5, wherein the controller generates the service alert based on the extreme brake event even if the estimated holding capability is greater than the predetermined threshold holding capability.

9. The brake system of claim 5, wherein the extreme brake event corresponds to an emergency stop condition.

10. The brake system of claim 1, wherein the assessment of the holding capability of the park brake is based on a plurality of ground speed signals received between receipt of the brake activation signal and when movement of the ground-engaging members has ceased.

11. A work vehicle, comprising:
a ground-engaging member supporting a chassis;
a service brake for stopping movement of the ground-engaging members when the service brake is engaged;
a park brake for preventing further movement of the ground-engaging members after movement of the ground-engaging members has been stopped by the service brake, wherein the park brake includes a friction pack and an actuator selectively engaging the friction pack to impede rotation of one or more of the ground-engaging members;
a ground speed sensor that generates ground speed signals indicative of a ground speed of the work vehicle;
a brake activation sensor that generates a brake activation signal each time the actuator engages the friction pack; and
a controller having a processing and memory architecture and configured to execute logic instructions to:
accumulate the brake activation signals generated by the brake activation sensor;
associate the brake activation signals with the ground speed signals received from the ground speed sensor;
determine if the actuator engaged the friction pack while the ground-engaging members were in motion based the brake activation signals and the ground speed signals and in response estimate a holding capability of the park brake; and
generate a service alert signal to an output device of the work vehicle when the estimated holding capability of the park brake is less than a predetermined threshold holding capability.

12. The work vehicle of claim 10, wherein the brake activation signals include a braking force amplitude and a braking duration.

13. The work vehicle of claim 12, wherein the controller assesses the braking force amplitude and the braking duration of the brake activation signals to estimate the holding capability of the park brake.

14. The work vehicle of claim 13, wherein the controller determines if an extreme brake event has occurred when the braking force amplitude above a predetermined threshold braking force and the braking duration is below a predetermined threshold braking duration and in response the controller generates the service alert corresponding to the extreme brake event.

15. The work vehicle of claim 14, wherein the controller applies a reduction factor to the estimated holding capability based on the extreme brake event.

16. The work vehicle of claim 15, wherein the reduction factor varies based on a magnitude of the sensed braking force amplitude over the predetermined braking force threshold.

17. The work vehicle of claim 15, wherein the reduction factor varies based on a magnitude of the sensed braking duration under the predetermined braking duration threshold.

18. The work vehicle of claim 15, Wherein the controller generates the service alert based on the extreme brake event even if the estimated holding capability is greater than the predetermined threshold holding capability.

19. The work vehicle of claim 15, wherein the extreme brake event corresponds to an emergency stop condition.

20. The work vehicle of claim 11, wherein the assessment of the holding capability of the park brake is based on a plurality of ground speed signals received between receipt of the brake activation signal and when movement of the ground-engaging member has ceased.
